(19) United States
(12) Patent Application Publication
(10) Pub. No.: US 2017/0117724 A1
(43) Pub. Date: Apr. 27, 2017

(54) BATTERY VOLTAGE-MULTIPLYING CHARGING CIRCUIT AND MOBILE TERMINAL

(71) Applicants: LE HOLDINGS (BEIJING) CO., LTD., Beijing (CN); Lemobile Information Technology (Beijing) Co., Ltd., Beijing (CN)

(72) Inventor: Fanbo KONG, Beijing (CN)

(21) Appl. No.: 15/232,693

(22) Filed: Aug. 9, 2016

Related U.S. Application Data
(63) Continuation of application No. PCT/CN2016/088217, filed on Jul. 1, 2016.

(30) Foreign Application Priority Data
Oct. 26, 2015 (CN) 201510703068.0

(51) Int. Cl. H02J 7/00; H01M 10/44

(52) U.S. Cl. CPC H02J 7/0024; H01M 10/44; H02J 7/0045

(57) ABSTRACT

Embodiments of the present disclosure disclose a battery voltage-multiplying charging circuit and a mobile terminal, the charging circuit comprises a charging port, a high voltage charging unit, a low voltage charging unit, a battery pack, and a system, the battery pack comprises a main battery and at least one second battery, and wherein the high voltage charging unit and the low voltage charging unit are connected with the charging port, respectively, and the low voltage charging unit is connected with the system and the battery pack, respectively; the high voltage charging unit is connected with the battery pack; during quick charging, the main battery and each second battery are switched to a series connection state, a charging voltage is transmitted to the high voltage charging unit and the low voltage charging unit via the charging port, and the high voltage charging unit charges the main battery and each second battery.

### CROSS-REFERENCE TO RELATED APPLICATIONS

The present disclosure is a continuation of International Application No. PCT/CN2016/088217 filed on Jul. 1, 2016, which is based upon and claims priority to Chinese Patent Application No. 201510703068.0, entitled “BATTERY VOLTAGE-MULTIPLYING CHARGING CIRCUIT AND MOBILE TERMINAL”, filed to State Intellectual Property Office of The P.R.C. on Oct. 26, 2015, the entire contents of all of which are incorporated herein by reference.

### FIELD OF TECHNOLOGY

The present disclosure generally relates to the technical field of batteries, and in particular relates to a battery voltage-multiplying charging circuit and a mobile terminal.

### BACKGROUND

With the increase of the capacity of a mobile phone battery, it has become one of the current hotspot technologies in realizing quick charging of batteries. Quick charging and slow charging of mobile phone batteries are generally defined by xC (e.g., 0.7 C, C, 1.5 C, 2 C, and so on) in the industry, wherein C represents the capacity of a battery, and x represents a charging rate; in case of the same battery capacity, the greater the charging rate is, the shorter the charging time is. However, for the design of the mobile phone batteries, the increase of the charging rate is more at the cost of reduction of energy density, and higher charging temperature rise. No matter whether the capacity of a battery is increased (e.g., from 2000 mAh to 3000 mAh) or the charging rate is increased, it will make higher requirements on the through-current capability of a charging circuit of a whole mobile phone at last; taking a 3000 mAh battery as an example, it is required that a charging branch circuit provides a 3000 mA current for IC charging; as for 2 C charging, it is required that the charging branch circuit has the ability of providing a 6000 mA current. Moreover, while the current providing ability of the charging branch circuit is considered, it also needs to take the issue of battery body heating during high current charging into account. It thus can be seen that it is a great challenge to realize quick battery charging not only for batteries, but also for the design of charging circuits, and heat dissipation.

Existing quick battery charging solutions can be mainly divided into the following two main classes as follows.

A charging architecture diagram of the battery charging solution of the first class is as shown in FIG. 1; the solution is specifically as follows: a current output by an AC (alternating current) charger is input into a battery directly, rather than via an intermediate charging unit, namely PMIC conversion.

Although such a solution may lead to that the heat loss of a charging branch circuit is transferred to the AC charger, such that heating of a mobile phone terminal can be partially effectively controlled, it has the following defects: first, the AC charger is complex to design, and required to be in real-time communication with a mobile phone to acquire the state of a mobile phone battery in real time so as to adjust a charging state. Second, according to the solution, the heat of a traditional charging unit only can be transferred to the AC charger terminal, and the problem of temperature rise caused by enabling a high current to flow through a mobile phone battery body to realize high rate charging cannot be solved. As the problem of temperature rise caused by the high current through the battery body cannot be solved, the solution fails in further increasing the charging rate. Experiments prove that 1.5 C has been the limit of quick charging such a solution can provide. Third, if a high current is used for charging, the through-current impedance of a charging channel also needs to be controlled strictly, and therefore, a connector, a charging port, and a charging cable all need to be selected specially, leading to non-universality of the charging accessories. Every time when the charging current is upgraded, the charging cable and the charging interface both need to be upgraded correspondingly. As a result, the implementation cost is high.

The battery charging solution of the second class is a high voltage charging solution, of which a charging architecture diagram is as shown in FIG. 2. The solution is specifically as follows: the output voltage of an AC charger is improved, such that electric energy is transmitted at a high power to a charging port of a mobile phone when universal connector, charging interface and charging cable are used, and then the output current ability of a charging unit is added to realize quick charging of a quick mobile phone battery.

The existing battery charging solution of the second class is not high in requirements on the design of the AC charger, and the existing charging interface and cable can be reused, and also, the charging accessories have good universality; however, such a solution still has the following defects: first, the conversion efficiency of the charging unit is about 90%, and the higher the passing power is, the greater the power loss is, and accordingly, the heavier the heating is. Although heat can be dispersed by adopting the dual-circuit solution, it is proven by experiments that the best through-current at present only can be 4.5 A, which is incapable of meeting the requirement of improving the charging current with the increase of the battery capacity. It also means that such a battery charging solution is limited by the power supply ability of the charging unit. Second, the issue of heat of the battery itself caused by high current charging is still not solved.

It thus can be seen that the existing quick battery charging solutions both have the issue of heating of the batteries themselves during high current charging.

### SUMMARY

Embodiments of the present disclosure disclose a battery voltage-multiplying charging circuit and a mobile terminal, which are intended to solve the issue of heating of the batteries themselves during high current charging in the existing quick battery charging solutions.

According to one aspect of the present disclosure, the present disclosure discloses a battery voltage-multiplying charging circuit, including a charging port, a high voltage charging unit, a low voltage charging unit, a battery pack, and a system, wherein the battery pack includes a main battery and at least one second battery, and wherein the high voltage charging unit and the low voltage charging unit are connected with the charging port, respectively, and the low voltage charging unit is connected with the system and the battery pack, respectively. The high voltage charging unit is connected with the battery pack; during quick charging, the main battery and each second battery are switched to a series connection state, a charging voltage is transmitted to the high voltage charging unit and the low voltage charging unit via the charging port, and the high voltage charging unit charges the main battery and each second battery. Meanwhile, the low voltage charging unit supplies power to the system; when charging is completed, the main battery and each second battery are switched to a parallel connection state to supply power to the system.

According to the other aspect of the present disclosure, the present disclosure also discloses a mobile terminal, which includes a battery voltage-multiplying charging circuit, wherein the battery voltage-multiplying charging circuit includes a charging port, a high voltage charging unit, a low voltage charging unit, a battery pack, and a system, wherein the battery pack includes a main battery and at least one second battery. The high voltage charging unit and the low voltage charging unit are connected with the charging port, respectively, and the low voltage charging unit is connected with the system and the battery pack, respectively. The high voltage charging unit is connected with the battery pack; during quick charging, the main battery and each second battery are switched to a series connection state, a charging voltage is transmitted to the high voltage charging unit and the low voltage charging unit via the charging port, and the high voltage charging unit charges the main battery and each second battery. Meanwhile, the low voltage charging unit supplies power to the system. When charging is completed, the main battery and each second battery are switched to a parallel connection state to supply power to the system.

The battery voltage-multiplying charging circuit provided by the embodiments of the present disclosure includes a high voltage charging unit, a low voltage charging unit, and a battery pack including a main battery and at least one second battery. During quick charging, the main battery and each second battery are switched to a series connection state, and the high voltage charging unit provides a multiplied voltage, namely a voltage higher than an existing common charging voltage by several times, for charging. Charging solutions that use multiplied voltage are capable of increasing the charging speed of the battery pack. Additionally, as the batteries in the battery pack are connected in series, the value of the current flowing through each battery still cannot be increased in spite of the improvement of the charging voltage. Therefore, it may not result in the issue of battery heating due to overhigh current flowing through the batteries. It thus can be seen that the battery voltage-multiplying charging circuit provided by the embodiments of the present disclosure is capable of effectively solving the issue of battery heating due to the increase of the current flowing through the battery bodies while providing quick charging for the batteries. Besides, when the battery voltage-multiplying charging circuit provided by the embodiments of the present disclosure charges the battery, it is configured that the low voltage charging unit rather than the battery pack to be charged supplies power to the system. When compared with the existing battery charging solutions where batteries need to supply power for systems while being charged, the battery charging speed can be increased as well.

The above descriptions are merely summary of the technical solutions of the present disclosure. In order to understand the technical means of the present disclosure more clearly, they can be implemented according to the contents of the description. In addition, in order to make the above and other objectives, features and advantages of the present disclosure more obvious and understandable, specific embodiments of the present disclosure are described below.

### BRIEF DESCRIPTION OF THE DRAWINGS

In order to describe the embodiments of the present disclosure or technical solutions in the prior art more clearly, accompanying drawings needing to be used in the descriptions of the embodiments or the prior art will be introduced briefly. It would be obvious that the accompanying drawings in the descriptions below are some embodiments of the present disclosure, and for a person ordinarily skilled in the art, other drawings may also be obtained according to the accompanying drawings without creative labor.

FIG. 1 is a charging architecture diagram of an existing quick charging solution of a first class.

FIG. 2 is a charging architecture diagram of an existing quick charging solution of a second class.

FIG. 3 is a schematic diagram of a battery voltage-multiplying charging circuit according to a first embodiment of the present disclosure.

FIG. 4 is a schematic diagram of a battery voltage-multiplying charging circuit according to a second embodiment of the present disclosure.

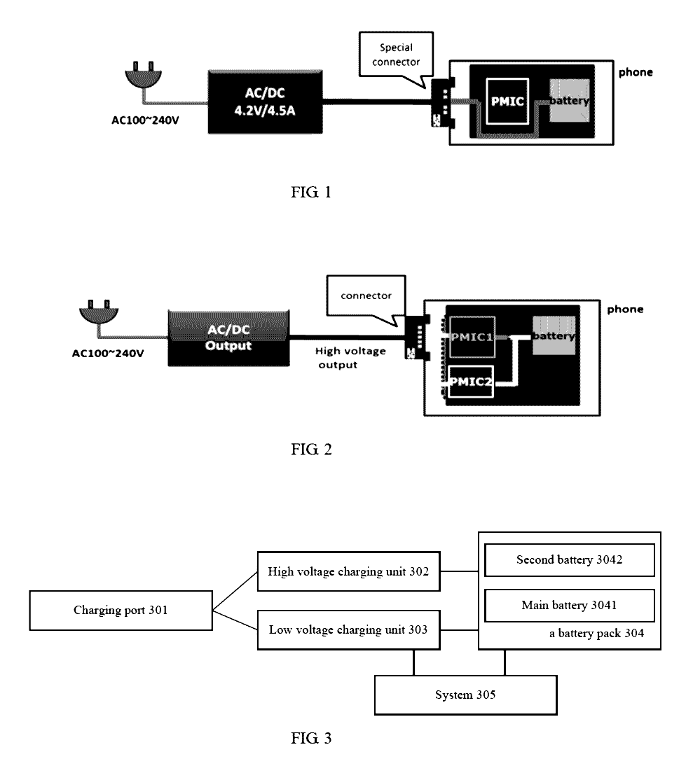

### DESCRIPTION OF THE EMBODIMENTS

In order to make the objectives, technical solutions and advantages of the embodiments of the present disclosure more clear, the technical solutions in the embodiments of the present disclosure will be described below clearly and completely in conjunction with the accompanying drawings in the embodiments of the present disclosure. Obviously, the described embodiments are part of embodiments of the present disclosure, not all embodiments. On the basis of the embodiments in the present disclosure, all the other embodiments obtained by people ordinarily skilled in the art without creative labor fall into the scope of protection of the present disclosure.

### A First Embodiment

By referring to FIG. 3, illustrated is a schematic diagram of a battery voltage-multiplying charging circuit according to a first embodiment of the present disclosure.

The battery voltage-multiplying charging circuit of this embodiment of the present disclosure includes a charging port 301, a high voltage charging unit 302, a low voltage charging unit 303, a battery pack 304, and a system 305, wherein the battery pack 304 includes a main battery 3041 and at least one second battery 3042.

Wherein, the high voltage charging unit 302 and the low voltage charging unit 303 are connected with the charging port 301, respectively, and the low voltage charging unit 303 is connected with the system 305 and the battery pack 304, respectively; the high voltage charging unit 302 is connected with the battery pack 304.

During quick charging, the main battery 3041 and each second battery are switched to a series connection state, a charging voltage is transmitted to the high voltage charging unit 302 and the low voltage charging unit 303 via the charging port 301, and the high voltage charging unit 302 charges the main battery 3041 and each second battery 3042; meanwhile, the low voltage charging unit 303 supplies power to the system 305; when charging is completed, the main battery 3041 and each second battery 3042 are switched to a parallel connection state to supply power to the system 305.

During quick charging, it is configured that the low voltage charging unit rather than the battery pack to be charged supplies power to the system, and the battery pack is only charged. Compared with an existing battery charging circuit where the battery needs to supply power for the system while being charged, the battery charging speed can be increased.

It needs to be noted that if the battery pack includes a plurality of second batteries, during quick charging, the main battery is connected in series with each second battery. When the charging is completed, the second batteries all are switched to the state of being connected in parallel.

By adopting the battery voltage-multiplying charging circuit of this embodiment of the present disclosure, although the multiplied voltage is employed, the value of the current flowing through various batteries in the battery pack can be effectively reduced because various batteries in the battery pack are connected in series, and further, heating of the battery bodies during charging can be reduced. The battery voltage-multiplying charging circuit of this embodiment of the present disclosure is capable of realizing quick charging by using a traditional charging architecture. Meanwhile, it is not limited by the increase of the charging rate in the future. For example, assuming that two 2000 mAh batteries are used for realizing 4000 mAh of charging, for an individual battery during series-connection voltage-multiplying charging, the charging rate is 1.5 C if the charging current is 3000 mA. Even though the charging rate needs to reach 2 C, the charging current is only required to be 4 A; this problem may be completely solved by the existing charging unit.

It needs to be noted that it is only exemplarily shown in FIG. 3 that the battery pack includes one second battery. However, in the specific implementation process, it is not limited to that the battery pack only includes one second battery as shown in this embodiment of the present disclosure, two, three, four or more second batteries may also be included. The specific number of the second batteries can be set by a person skilled in the art according to actual requirements in the specific implementation process, which is not specifically limited in this embodiment of the present disclosure.

The battery voltage-multiplying charging circuit of this embodiment of the present disclosure is suitable for any appropriate mobile terminal, such as a mobile phone, a tablet computer, and the like, and provides the mobile terminal with the quick charging function.

By means of the battery voltage-multiplying charging circuit of this embodiment of the present disclosure, during quick charging, the main battery and each second battery are switched to the series connection state, and the high voltage charging unit provides a multiplied voltage, namely a voltage higher than an existing common charging voltage by several times, for charging. By means of the method of charging with the multiplied voltage, the charging speed of the battery pack can be increased. Additionally, as the batteries in the battery pack are connected in series, the value of the current flowing through each battery still cannot be increased in spite of the improvement of the charging voltage, and therefore, it may not result in the issue of battery heating due to overhigh current flowing through the batteries. It thus can be seen that the battery voltage-multiplying charging circuit provided by this embodiment of the present disclosure is capable of effectively solving the issue of battery heating due to the increase of the current flowing through the battery bodies while providing quick charging for the batteries.

### A Second Embodiment

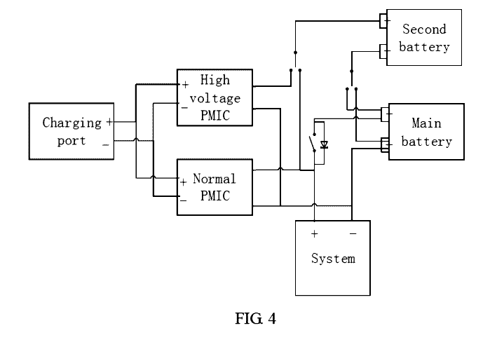

By referring to FIG. 4, illustrated is a schematic diagram of a battery voltage-multiplying charging circuit according to a second embodiment of the present disclosure.

As shown in FIG. 4, the battery voltage-multiplying charging circuit provided by this embodiment of the present disclosure includes a charging port, a high voltage charging unit, namely high voltage PMIC, a low voltage charging unit, a battery pack, and a system, wherein the battery pack includes a main battery and a second battery; wherein the low voltage charging unit is a normal PMIC to provide the battery pack with conventional-mode charging.

As shown in FIG. 4, in the battery voltage-multiplying charging circuit, the high voltage charging unit and the low voltage charging unit are connected with the charging port, respectively, the low voltage charging unit is connected with the system and the battery pack, respectively, and the high voltage charging unit is connected with the battery pack. Specifically, a first switch is arranged between a positive electrode of the second battery, and a positive electrode of the high voltage charging unit as well as a positive electrode of the low voltage charging unit. A second switch is arranged between a negative electrode of the second battery, and a positive electrode of the main battery as well as a negative electrode of the main battery. The negative electrode of the main battery is connected with a negative electrode of the high voltage charging unit, and a negative electrode of the low voltage charging unit. A third switch is arranged between the positive electrode of the main battery and the positive electrode of the low voltage charging unit. In addition, a triode is arranged between the positive electrode of the main battery and the positive electrode of the low voltage charging unit, and connected in parallel with the third switch. Wherein, the first switch and the second switch may be single-pole double-throw switches, and the third switch may be a single-pole single-throw switch.

During quick charging, the first switch is adjusted to switch on the positive electrode of the second battery with the positive electrode of the high voltage charging unit, the second switch is adjusted to switch on the negative electrode of the second battery with the positive electrode of the main battery, and the third switch is adjusted to switch on the positive electrode of the main battery with the positive electrode of the low voltage charging unit.

By adjusting the three switches in the above way, the battery voltage-multiplying charging circuit may be controlled to supply power for the battery pack via the high voltage charging unit, and the low voltage charging unit supplies power for the system; in addition, the main battery and the second battery in the battery pack are connected in series. Finally, a voltage-multiplying quick charging process without increasing the current flowing through each battery in the battery pack is realized.

When quick charging is completed, the second switch is adjusted to switch on the negative electrode of the second battery with the negative electrode of the main battery, such that the main battery and the second battery are switched to the parallel connection state to supply power for the system.

In this embodiment of the present disclosure, the objective of arranging the triode connected in parallel with the third switch in the voltage-multiplying charging circuit is: when the third switch is opened (i.e., the positive electrode of the main battery is disconnected from the positive electrode of the low voltage charging unit), the output voltage of the low voltage charging unit is set to be higher than the maximum charging voltage of the main battery, and as the output voltage of the low voltage charging unit is higher than the voltage of the main battery side, the triode is not switched on; in this way, it can be realized that the low voltage charging unit rather than the main battery supplies power for the system.

During conventional charging, the first switch is adjusted to switch the positive electrode of the second battery with the positive electrode of the low voltage charging unit, the second switch is adjusted to switch the negative electrode of the second battery with the negative electrode of the main battery, and the third switch is adjusted to switch the positive electrode of the main battery with the positive electrode of the low voltage charging unit.

By adjusting the three switches in the above way, the battery voltage-multiplying charging circuit may be controlled to supply power for the battery pack via the low voltage charging unit, and the main battery supplies power for the system; in addition, the main battery and the second battery in the battery pack are connected in series. That is to say, a conventional voltage is adopted to charge the battery pack, and the battery pack supplies power for the system while being charged.

It thus can be seen that the battery voltage-multiplying charging circuit provided by this embodiment of the present disclosure does not give up the Normal PMIC, and without a special quick charger, a Normal charger can also be used to charge the batteries. The battery voltage-multiplying charging circuit is capable of meeting either the requirement on quick charging of the batteries or the requirement on conventional charging of the batteries. The charging circuit may decide which charging mode is adopted according to whether the quick charger is used by a user. In order to guarantee balanced charging, during voltage-multiplying charging, namely quick charging, it is required that the single-pole single throw switch, namely the third switch, as shown in the figure should be opened, and the output voltage of the Normal PMIC is set to be higher than the maximum charging voltage of the batteries, such that the Normal PMIC is used to supply power for the system. As a result, the charging current can be prevented from being shunt by the system.

Specifically, when the battery voltage-multiplying charging circuit chooses whether to perform quick charging or conventional charging on the batteries, the charging modes are switched according to the connected chargers. If the connected charger is the quick charger, quick charging is carried out, and if the connected charger is a conventional power charger, conventional charging is carried out.

It needs to be noted that the descriptions in this embodiment of the present disclosure are made by taking the battery pack including only one second battery as an example. In the specific implementation process, two, three, four or more second batteries may also be arranged in the battery pack, and the specific number of the second batteries can be set by a person skilled in the art according to actual requirements, which is not specifically limited in this embodiment of the present disclosure.

Table 1 is a statistical table of the highest voltages born by the series-connected batteries, the output voltages of the high voltage charging unit, and the output voltages of an AC charger when the battery pack includes different batteries and the charging circuit is used for quick charging.

TABLE 1

| | Series-connection | PMIC output | Output voltage of AC |
|---|---|---|---|
| | highest voltage | voltage | charger |
| 2 batteries | 8.8 V | 9 V | 9 V |
| connected in | | | |
| series | | | |
| 3 batteries | 13.4 V | 14 V | 15 V |
| connected in | | | |
| series | | | |
| 4 batteries | 17.8 V | 18 V | 20 V |
| connected in | | | |
| series | | | |

In this embodiment of the present disclosure, it needs to focus on the following four aspects for the design of the battery voltage-multiplying charging circuit: first, the requirement on the AC charger capable of being matched with the battery voltage-multiplying charging circuit in use is not complex, and it only requires that the AC charger has a handshake mechanism with a mobile phone to realize step-up output. The AC charger can be the present commercial mature quick charger alternatively, the AC charger may also be developed originally, and a charging protocol is also developed originally, which is only required to have the handshake mechanism to step up the voltage without monitoring the battery charging state in real time. Second, with respect to a charging interface and a charging cable, the use requirement of quick charging may be met completely just by using the existing charging accessories. Third, the charging unit is designed to be compatible with voltage-multiplying charging and common charging. Fourth, series connection and parallel connection of the batteries are switched; in the usual mode, the various batteries in the battery pack are connected in parallel, and only when quick charging is required, the various batteries in the battery pack are connected in series. The switching of series connection and parallel connection can be realized by switching with switches; however, it needs to guarantee that the main battery is always connected to the system so as to supply power for the system after conventional charging or charging is completed.

In this embodiment of the present disclosure, in addition to the description of the working principle of the battery voltage-multiplying charging circuit, also provided is a method for determining whether the batteries in the battery pack are damaged.

As the various batteries in the battery pack are connected in series to be charged and connected in parallel to be discharged, the total electric quantity of the battery pack can be reported by means of a method of only collecting the charging and discharging quantities of the Main battery. Alternatively, an electricity meter is built in each battery to collect the electric quantity of each battery so as to determine the total electric quantity of the battery pack. Subsequently, after the total electric quantity of the battery pack is determined, the obtained total electric quantity is compared with the total electric quantity of the battery pack under the circumstance of no damaged battery exists in the battery pack. If the twice total electric quantities of the battery pack differs much, it can be determined that the battery in the battery pack is damaged.

By means of the battery voltage-multiplying charging circuit of this embodiment of the present disclosure, during quick charging, the main battery and each second battery are switched to the series connection state, and the high voltage charging unit provides a multiplied voltage, namely a voltage higher than the existing common charging voltage by several times, for charging. By means of the method of charging with the multiplied voltage, the charging speed of the battery pack can be increased. Additionally, as the batteries in the battery pack are connected in series, the value of the current flowing through each battery still cannot be increased in spite of the improvement of the charging voltage, and therefore, it may not result in the issue of battery heating due to overhigh current flowing through the batteries. It thus can be seen that the battery voltage-multiplying charging circuit provided by this embodiment of the present disclosure is capable of effectively solving the issue of battery heating due to the increase of the current flowing through the battery bodies while providing quick charging for the batteries.

Another embodiment of the present disclosure also sets forth a mobile terminal. The mobile terminal includes the battery voltage-multiplying charging circuit set forth in the present disclosure. The specific arrangement position of the circuit in the mobile terminal may be set by a person skilled in the art according to actual requirements, which is not described redundantly in the embodiment of the present disclosure.

The battery voltage-multiplying charging circuit provided by the embodiment of the present disclosure includes a charging port, a high voltage charging unit, a low voltage charging unit, a battery pack, and a system, wherein the battery pack includes a main battery and at least one secondary battery; the high voltage charging unit and the low voltage charging unit are connected with the charging port, respectively, and the low voltage charging unit is connected with the system and the battery pack, respectively; the high voltage charging unit is connected with the battery pack.

During quick charging, the main battery and each second battery are switched to a series connection state, a charging voltage is transmitted to the high voltage charging unit and the low voltage charging unit via the charging port, and the high voltage charging unit charges the main battery and each second battery. Meanwhile, the low voltage charging unit supplies power to the system, when charging is completed, the main battery and each second battery are switched to a parallel connection state to supply power to the system.

Preferably, the battery pack in the battery voltage-multiplying charging circuit included in the mobile terminal only includes one second battery. A first switch is arranged between a positive electrode of the second battery, and a positive electrode of the high voltage charging unit as well as a positive electrode of the low voltage charging unit. A second switch is arranged between a negative electrode of the second battery, and a positive electrode of the main battery as well as a negative electrode of the main battery. The negative electrode of the main battery is connected with a negative electrode of the high voltage charging unit, and a negative electrode of the low voltage charging unit; a third switch is arranged between the positive electrode of the main battery and the positive electrode of the low voltage charging unit.

Preferably, during quick charging, the first switch is adjusted to switch on the positive electrode of the second battery with the positive electrode of the high voltage charging unit, the second switch is adjusted to switch on the negative electrode of the second battery with the positive electrode of the main battery, and the third switch is adjusted to switch on the positive electrode of the main battery with the positive electrode of the low voltage charging unit.

Preferably, during conventional charging, the first switch is adjusted to switch the positive electrode of the second battery with the positive electrode of the low voltage charging unit, the second switch is adjusted to switch the negative electrode of the second battery with the negative electrode of the main battery, and the third switch is adjusted to switch the positive electrode of the main battery with the positive electrode of the low voltage charging unit.

Preferably, in the battery voltage-multiplying charging circuit, a triode is arranged between the positive electrode of the main battery and the positive electrode of the low voltage charging unit, and connected in parallel with the third switch.

With respect to the specific structure of the battery voltage-multiplying charging circuit included in the mobile terminal, see the battery voltage-multiplying charging circuit in the first embodiment and the second embodiment, which is not redundantly described herein.

The device embodiment described above is merely exemplary, wherein units described as separate parts may be or not separated physically, and parts displayed as units may be or not physical units, which may be located at the same place, or may also be distributed on a plurality of network units. Partial or all modules therein may be selected according to actual requirements to achieve the objectives of the solutions of the present embodiment. The solutions can be understood and implemented by a person ordinarily skilled in the art without creative labor.

According to the descriptions of the above embodiments, it can be clearly understood by a person skilled in the art that each embodiment can be implemented by means of software and necessary universal hardware platform of course, hardware may also be possible. On the basis of such understanding, the technical solutions in nature or parts thereof contributing to the prior art may be embodied in the form of a software product. The software product can be stored in a computer readable storage medium, such as ROM/RAM, a magnetic disk, an optical disk, and the like, and includes a plurality of instructions to enable a computer device (which may be a personal computer, a server, a network device, or the like) to execute the method described in each embodiment or some parts of the embodiments.

It should be noted at last that the above embodiments are merely meant to illustrate the technical solutions of the present disclosure, and not meant to limiting. Although the present disclosure is described in detail with reference to the forgoing embodiments, it should be appreciated by a person ordinarily skilled in the art that the technical solutions described in each forgoing embodiment still can be modified, or partial technical features therein may be equivalently substituted. Moreover, these modifications or substitutions do not cause the nature of the corresponding technical solutions to depart from the concept and scope of the technical solutions in various embodiments of the present disclosure.

What is claimed is:

1. A battery voltage-multiplying charging circuit, comprising a charging port, a high voltage charging unit, a low voltage charging unit, a battery pack, and a system, wherein the battery pack comprises a main battery and at least one second battery;
wherein the high voltage charging unit and the low voltage charging unit are connected with the charging port, respectively, and the low voltage charging unit is connected with the system and the battery pack, respectively;
the high voltage charging unit is connected with the battery pack;
during quick charging, the main battery and each second battery are switched to a series connection state, a charging voltage is transmitted to the high voltage charging unit and the low voltage charging unit via the charging port, and the high voltage charging unit charges the main battery and each second battery; and the low voltage charging unit supplies power to the system;
when charging is completed, the main battery and each second battery are switched to a parallel connection state to supply power to the system.

2. The charging circuit according to claim 1, wherein the battery pack comprises only one second battery;
a first switch is arranged between a positive electrode of the second battery, and a positive electrode of the high voltage charging unit as well as a positive electrode of the low voltage charging unit;
a second switch is arranged between a negative electrode of the second battery, and a positive electrode of the main battery as well as a negative electrode of the main battery, the negative electrode of the main battery is connected with a negative electrode of the high voltage charging unit, and a negative electrode of the low voltage charging unit;
a third switch is arranged between the positive electrode of the main battery and the positive electrode of the low voltage charging unit.

3. The charging circuit according to claim 2, wherein
during quick charging, the first switch is adjusted to switch on the positive electrode of the second battery with the positive electrode of the high voltage charging unit, the second switch is adjusted to switch on the negative electrode of the second battery with the positive electrode of the main battery, and the third switch is adjusted to switch on the positive electrode of the main battery with the positive electrode of the low voltage charging unit.

4. The charging circuit according to claim 2, wherein
during normal charging, the first switch is adjusted to switch on the positive electrode of the second battery with the positive electrode of the low voltage charging unit, the second switch is adjusted to switch on the negative electrode of the second battery with the negative electrode of the main battery, and the third switch is adjusted to switch on the positive electrode of the main battery with the positive electrode of the low voltage charging unit.

5. The charging circuit according to claim 4, wherein
a triode is arranged between the positive electrode of the main battery and the positive electrode of the low voltage charging unit, and connected in parallel with the third switch.

6. A mobile terminal, comprising a battery voltage-multiplying charging circuit,
wherein the battery voltage-multiplying charging circuit comprises a charging port, a high voltage charging unit, a low voltage charging unit, a battery pack, and a system, wherein the battery pack comprises a main battery and at least one second battery;
the high voltage charging unit and the low voltage charging unit are connected with the charging port, respectively, and the low voltage charging unit is connected with the system and the battery pack, respectively;
the high voltage charging unit is connected with the battery pack;
during quick charging, the main battery and each second battery are switched to a series connection state, a charging voltage is transmitted to the high voltage charging unit and the low voltage charging unit via the charging port, and the high voltage charging unit charges the main battery and each second battery; meanwhile, the low voltage charging unit supplies power to the system;
when charging is completed, the main battery and each second battery are switched to a parallel connection state to supply power to the system.

7. The mobile terminal according to claim 6, wherein the battery pack comprises only one second battery;
a first switch is arranged between a positive electrode of the second battery, and a positive electrode of the high voltage charging unit as well as a positive electrode of the low voltage charging unit;
a second switch is arranged between a negative electrode of the second battery, and a positive electrode of the main battery as well as a negative electrode of the main battery; the negative electrode of the main battery is connected with a negative electrode of the high voltage charging unit, and a negative electrode of the low voltage charging unit;
a third switch is arranged between the positive electrode of the main battery and the positive electrode of the low voltage charging unit.

8. The mobile terminal according to claim 7, wherein
during quick charging, the first switch is adjusted to switch on the positive electrode of the second battery with the positive electrode of the high voltage charging unit, the second switch is adjusted to switch on the negative electrode of the second battery with the positive electrode of the main battery, and the third switch is adjusted to switch on the positive electrode of the main battery with the positive electrode of the low voltage charging unit.

9. The mobile terminal according to claim 8, wherein
during normal charging, the first switch is adjusted to switch on the positive electrode of the second battery with the positive electrode of the low voltage charging unit, the second switch is adjusted to switch on the negative electrode of the second battery with the negative electrode of the main battery, and the third switch is adjusted to switch on the positive electrode of the main battery with the positive electrode of the low voltage charging unit.

10. The mobile terminal according to claim 9, wherein
in the battery voltage-multiplying charging circuit, a triode is arranged between the positive electrode of the main battery and the positive electrode of the low voltage charging unit, and connected in parallel with the third switch.
